(19) United States
(12) Patent Application Publication
(10) Pub. No.: US 2015/0134294 A1
(43) Pub. Date: May 14, 2015

(54) ATTITUDE CALCULATION APPARATUS AND ATTITUDE CALCULATION METHOD

(71) Applicant: Seiko Epson Corporation, Shinjuku-ku (JP)

(72) Inventors: Shunichi MIZUOCHI, Matsumoto-shi (JP); Katsuhiko Maki, Chino-shi (JP); Katsuhito Nakajima, Hachioji-shi (JP)

(21) Appl. No.: 14/535,186

(22) Filed: Nov. 6, 2014

(30) Foreign Application Priority Data
Nov. 11, 2013 (JP) 2013-233373

(51) Int. Cl. G01C 19/02; G01P 3/00

(52) U.S. Cl. CPC G01C 19/02; G01P 3/00
USPC 702/151

(57) ABSTRACT

An attitude calculation apparatus includes a gyro sensor that detects angular velocity in a first coordinate system for an inertial coordinate system, of a living body or a moving object which moves by using energy of the living body as a power source, an attitude change calculation unit that calculates an attitude change of the moving object on the basis of the angular velocity which is input at a first frequency f1, and an attitude update unit that updates an attitude of the moving object on the basis of the attitude change which is input at a second frequency f2, in which the first frequency and the second frequency satisfy f1>f2≧20 Hz.

### BACKGROUND

1. Technical Field

The present invention relates to an attitude calculation apparatus and an attitude calculation method.

2. Related Art

In an inertial navigation system, a method is known in which an attitude of an apparatus equipped with the system or a moving object equipped with the apparatus is calculated by using output of an angular velocity sensor.

JP-A-2001-280970 discloses that, in order to compute an attitude angle with relatively high accuracy at a high speed, an initial value for performing an attitude reference computation at a relatively high calculation frequency through relatively low-order approximate calculation is corrected by using a result in which an attitude reference computation is performed at a relatively low calculation frequency through relatively high-order approximate calculation.

In JP-A-2001-280970, the correction is performed by using the result in which an attitude reference computation is performed at a relatively low calculation frequency. Calculation having a low calculation frequency uses gyro data which is input in a cycle which is lower than calculation having a high calculation frequency. For this reason, there is a large amount of gyro data which is not used for the calculation, and thus there is a probability that accurate correction may not be performed.

Particularly, in a case where a moving object which changes greatly in angular velocity for a short time is targeted, such as a human, if there is a large amount of data which is not used, errors increase, and accuracy of a calculated attitude angle tends to be reduced. On the other hand, since calculation of an attitude requires a large calculation amount, there is a need for reducing a load on a system which performs the calculation.

### SUMMARY

An advantage of some aspects of the invention is to provide an attitude calculation apparatus and an attitude calculation method in which a load on a system can be minimized, and attitude calculation accuracy is barely reduced even if a moving object whose angular velocity changes greatly is targeted.

(1) An aspect of the invention relates to an attitude calculation apparatus including a gyro sensor that detects angular velocity in a first coordinate system for an inertial coordinate system, of a living body or a moving object (hereinafter, collectively referred to as a “moving object”) which moves by using energy of the living body as a power source; an attitude change calculation unit that calculates an attitude change of the moving object on the basis of the angular velocity which is input at a first frequency f1; and an attitude update unit that updates an attitude of the moving object on the basis of the attitude change which is input at a second frequency f2, in which the first frequency and the second frequency satisfy f1>f2≧20 Hz.

In the attitude calculation apparatus according to the aspect of the invention, angular velocity is input to the attitude change calculation unit at the first frequency f1, and an attitude change is input to the attitude update unit at the second frequency f2. As a result of examination conducted by the present inventors, it is found that, if f1>f2≧20 Hz, an attitude change is calculated at the first frequency f1 higher than the second frequency f2, and thus the attitude change can be calculated with higher accuracy than in a case where the attitude change is calculated at the second frequency f2. Therefore, even in a case where an angular velocity change is relatively great as in a moving object which walks and moves, it is possible to minimize a reduction in attitude calculation accuracy. On the other hand, an attitude change is input to the attitude update unit at the second frequency f2 which is lower than the first frequency f1. Thus, a load on the CPU in calculation after an attitude is updated is reduced.

(2) In the aspect of the invention, the attitude change calculation unit may calculate exp([α_{ib}^{b}(t+τ₁)]×)exp([α_{ib}^{b}(t+2τ₁)]×) . . . exp([α_{ib}^{b}(t+kτ₁)]×). Here, τ₁ is 1/f1; k is an integer satisfying (f1/f2)−1<kf1/f2; t indicates time; and [α_{ib}^{b}(t+nτ₁)] indicates a rotation matrix obtained from the angular velocity at a time point t+nτ₁ (where n is an integer satisfying 1≦n≦k).

By using the n-th attitude change exp[α(t+nτ₁)] every first cycle τ1, multiplication and calculation are performed k times such as exp([α(t+τ)]×)exp([α(t+2τ)]×) . . . exp([α(t+kτ)]×), and thus an attitude change of the moving object can be calculated with high accuracy. In addition, the first cycle τ₁ and the second cycle τ₂ and the above-described first and second frequencies f1 and f2 have relationships of τ₁=1/f1 and τ₂=1/f2. Therefore, k=f1/f2 is satisfied. Further, even if f1/f2 does not become an integer, k is the number of α matrices which can be multiplied within a period, and thus k can be made an integer satisfying (f1/f2)−1<k≦f1/f2.

(3) In the aspect of the invention, the attitude calculation apparatus may further include an acceleration sensor that detects acceleration in the first coordinate system for the inertial coordinate system; and a coordinate conversion unit that converts coordinates of the acceleration from the first coordinate system into a second coordinate system on the basis of the attitude and the acceleration which is input at the second frequency f2.

An attitude is updated by using an attitude change which is calculated on the basis of angular velocity input at the first frequency f1. For this reason, coordinates of acceleration can be converted with high accuracy by using the attitude.

(4) In the aspect of the invention, the attitude calculation apparatus may further include a sensor unit that includes the gyro sensor, and the attitude change calculation unit may be configured by hardware which is accommodated in the sensor unit.

Typically, an attitude change can be obtained through common calculation regardless of a specification of the system. Therefore, the attitude change calculation unit is configured by hardware, and thus it is possible to reduce a load on the CPU due to calculation using the relatively high first frequency f1.

(5) In the aspect of the invention, the attitude calculation apparatus may further include an addition averaging unit that adds and averages the m accelerations (where m is an integer of 2 or higher, and satisfies f3/f2) which have been input at a third frequency f3 (f2<f3<f1), and inputs the acceleration to the attitude update unit at the second frequency f2.

A frequency at which the acceleration sensor detects acceleration may not match the second frequency f2. In a case where acceleration is detected at the third frequency f3, higher than the second frequency f2, m (=f3/f2) accelerations which are acquired may be added and averaged. The accelerations are integrated for a smaller number of times, for example, when a position is calculated rather than the angular velocities, and thus even if the accelerations are added and averaged, there is less influence of an increase in an error due to the integration. For this reason, a calculation amount can be minimized, and a reduction in accuracy of subsequent calculation can be prevented.

(6) In the aspect of the invention, the attitude update unit may output a request signal for a request for outputting the attitude change from the attitude change calculation unit at the second frequency f2, to the attitude change calculation unit.

Since the request signal is output from the attitude update unit, a frequency at which an attitude change is input to the attitude update unit can be accurately maintained, and thus it is possible to minimize a reduction in calculation accuracy of an attitude.

(7) Another aspect of the invention relates to an attitude calculation method including detecting angular velocity in a first coordinate system for an inertial coordinate system, of a living body or a moving object (hereinafter, collectively referred to as a “moving object”) which moves by using energy of the living body as a power source; calculating an attitude change of the moving object on the basis of the angular velocity which is input at a first frequency f1; and updating an attitude of the moving object on the basis of the attitude change which is input at a second frequency f2, in which the first frequency and the second frequency satisfy f1>f2≧20 Hz.

Also in the another aspect of the invention, even if an angular velocity change is relatively great as in a moving object which walks and moves, it is possible to minimize deterioration in integration accuracy and thus to reduce a load on the CPU when an attitude is calculated for updating the attitude.

### BRIEF DESCRIPTION OF THE DRAWINGS

The invention will be described with reference to the accompanying drawings, wherein like numbers reference like elements.

FIG. 1 is a diagram illustrating a configuration example of the entire system of a position calculation apparatus.

FIG. 2 is a functional block diagram of the position calculation apparatus.

FIG. 3 is a block diagram of a gyro sensor IC and a processing unit.

FIG. 4 is a flowchart illustrating operations of the functional blocks illustrated in FIG. 3.

FIG. 5 is a block diagram illustrating details of the gyro sensor IC.

FIG. 6 is a functional block diagram of an attitude change calculation unit of the gyro sensor IC.

FIG. 7 is a hardware configuration diagram of the attitude change calculation unit.

FIG. 8A is a diagram illustrating an initialization operation of a C register.

FIG. 8B is a diagram illustrating α matrix calculation.

FIG. 8C is a diagram illustrating an exp calculation operation.

FIG. 9 is a flowchart illustrating an integration operation of attitude changes in the attitude change calculation unit.

FIG. 10 is a flowchart illustrating an operation in a comparative example.

FIG. 11 is a diagram illustrating an error generated when a position of a moving object which moves at a dash is calculated in the present example and a comparative example.

FIG. 12 is a diagram illustrating an error generated when a position of a moving object which runs and moves is calculated in the present example and a comparative example.

FIG. 13 is a diagram illustrating an error generated when a position of a moving object which moves on foot is calculated in the present example and a comparative example.

FIG. 14 is a diagram illustrating a comparison result in the same condition as in FIG. 11 except that a second frequency is reduced.

FIG. 15 is a diagram illustrating a comparison result in the same condition as in FIG. 12 except that the second frequency is reduced.

FIG. 16 is a diagram illustrating a comparison result in the same condition as in FIG. 13 except that the second frequency is reduced.

FIG. 17 is a diagram illustrating an operation flowchart of Modification Example in which a main function of a processing unit is realized by hardware.

### DESCRIPTION OF EXEMPLARY EMBODIMENTS

Hereinafter, with reference to the drawings, an example of a preferred embodiment of the invention will be described. However, an embodiment to which the invention is applicable is not limited to the embodiment described below.

### 1. SYSTEM CONFIGURATION

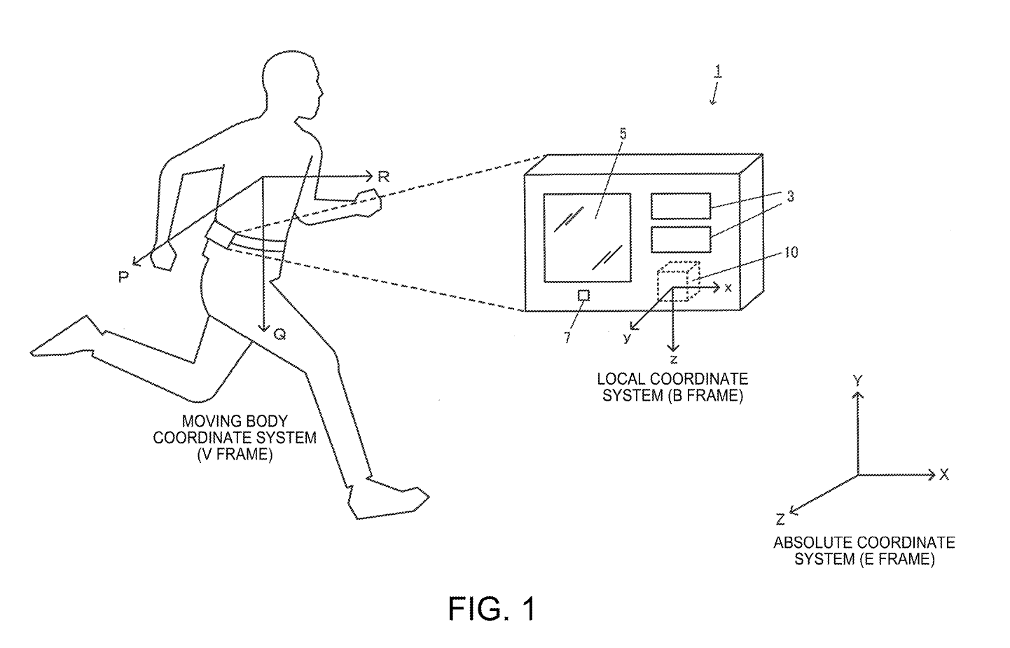

FIG. 1 is a diagram illustrating a configuration example of the entire system of a position calculation apparatus 1 in the present embodiment. The position calculation apparatus 1 is a small-sized electronic apparatus which is mounted on a living body or a moving object which moves by using energy of the living body as a power source, for example, on a human waist (a right waist or a left waist), and is a kind of position calculation apparatus which calculates and displays a position of a moving object. The position calculation apparatus 1 includes operation buttons 3 which are input devices which allows a moving object to input various operations related to calculation of a position, a liquid crystal display 5 on which information such as a calculated position is displayed, and a speaker 7. In addition, in the present specification, the above-described living body and moving object are collectively referred to as a “moving object”.

In the present embodiment, at least three types of coordinate systems are defined. A first coordinate system is a local coordinate system which is a three-dimensional orthogonal coordinate system (sensor coordinate system) correlated with an inertial measurement unit (IMU) 10 provided in the position calculation apparatus 1. In the present specification, the local coordinate system is also referred to as a body (B) frame which represents detection axes of an inertial sensor in a right-handed system. In the present embodiment, three axes of the local coordinate system are denoted by an x axis, a y axis, and a z axis.

A second coordinate system is a three-dimensional orthogonal coordinate system (absolute coordinate system) which is a coordinate system for defining a movement space of a moving object. In the present specification, the absolute coordinate system is also referred to as an absolute (A) frame. The A frame is defined as, for example, a north east down (NED) coordinate system (N frame), or an earth centered earth fixed (ECEF) coordinate system (E frame). In the present embodiment, three axes of the absolute coordinate system are denoted by an X axis, a Y axis, and a Z axis.

The second coordinate system may be a three-dimensional orthogonal coordinate system (moving object coordinate system) correlated with a moving object. In the present specification, the moving object coordinate system is also referred to as a vehicle (V) frame. In the present embodiment, a front and rear direction with a front side of a moving object as a positive side is set to a roll axis (R axis), a left and right direction with a right side as a positive side is set to a pitch axis (P axis), and an up and down direction with a vertical lower side as a positive side is set to a yaw axis (Q axis).

The third coordinate system is an inertial coordinate system (not illustrated) which is a three-dimensional orthogonal coordinate system used as a reference when the IMU 10 performs detection. In the present specification, the inertial coordinate system is also referred to as an inertial (I) frame. The I frame is a coordinate system which has the center of the Earth as an origin, and has the Earth's axis of rotation as one axis. The rotation of the Earth is disregarded. In the present embodiment, three axes of the inertial coordinate system are denoted by an L axis, an M axis, and an N axis. In the present embodiment, the N axis is set to the Earth's axis of rotation.

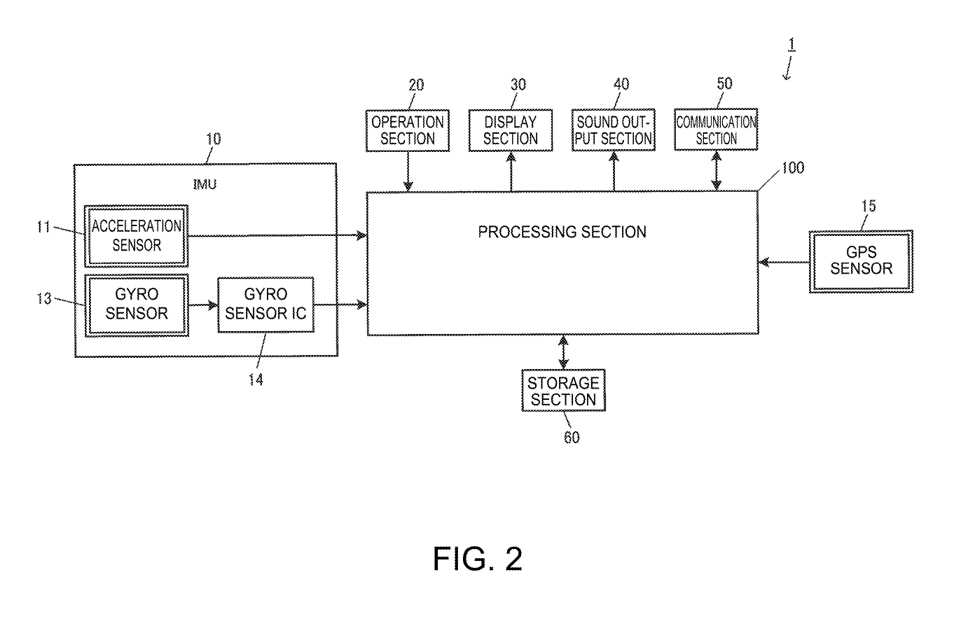

The IMU 10 is a sensor unit which is mounted in the position calculation apparatus 1, and is known as an inertial navigation unit. The IMU 10 includes, as illustrated in FIG. 2, an acceleration sensor 11, a gyro sensor 13, and a gyro sensor IC 14 having an attitude change calculation unit. As illustrated in FIG. 1, the z axis of the IMU 10 is a vertical axis.

The acceleration sensor 11 detects acceleration vectors for the respective axes (the L axis, the M axis, and the N axis) of the inertial coordinate system corresponding to the three axes (the x axis, the y axis, and the z axis) of the local coordinate system. As the acceleration sensor 11, for example, a micro electromechanical systems (MEMS) sensor is used. A value measured by the acceleration sensor 11 is acceleration of a moving object measured in the local coordinate system.

In the present specification, in principle, unless otherwise mentioned, acceleration or velocity indicates acceleration or velocity (that is, an acceleration vector or a velocity vector) which takes into consideration a direction and a magnitude thereof.

The gyro sensor 13 detects angular velocity (hereinafter, referred to as “local coordinate angular velocity”) for the respective axes (the L axis, the M axis, and the N axis) of the inertial coordinate system corresponding to the three axes (the x axis, the y axis, and the z axis) of the local coordinate system in the same manner as in the acceleration sensor 11 provided in the position calculation apparatus 1.

A global positioning system (GPS) sensor 15 illustrated in FIG. 2 is a sensor which receives a GPS satellite signal transmitted from a GPS satellite which is a kind of a positioning satellite, and calculates a position and a velocity vector of a moving object by using the GPS satellite signal. A method of calculating a position or a velocity vector by using a GPS is well known in the related art, and detailed description thereof will be omitted.

The position calculation apparatus 1 further includes a processing section 100, an operation section 20 provided with the operation buttons 3 illustrated in FIG. 1, a display section 30 provided with the liquid crystal display 5 illustrated in FIG. 1, a sound output section 40 provided with the speaker 7 illustrated in FIG. 1, a communication section 50, and a storage section 60.

The processing section 100 collectively controls the respective sections of the position calculation apparatus 1 according to various programs such as a system program stored in the storage unit 60.

### 2. GYRO SENSOR IC AND PROCESSING SECTION

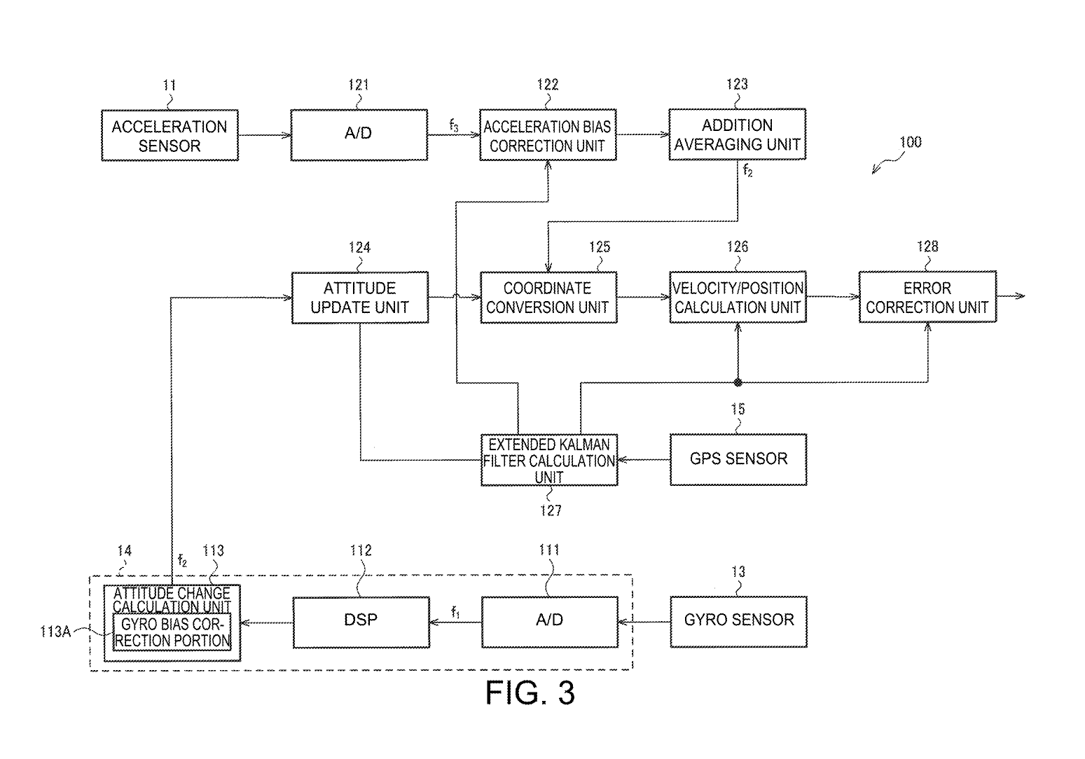

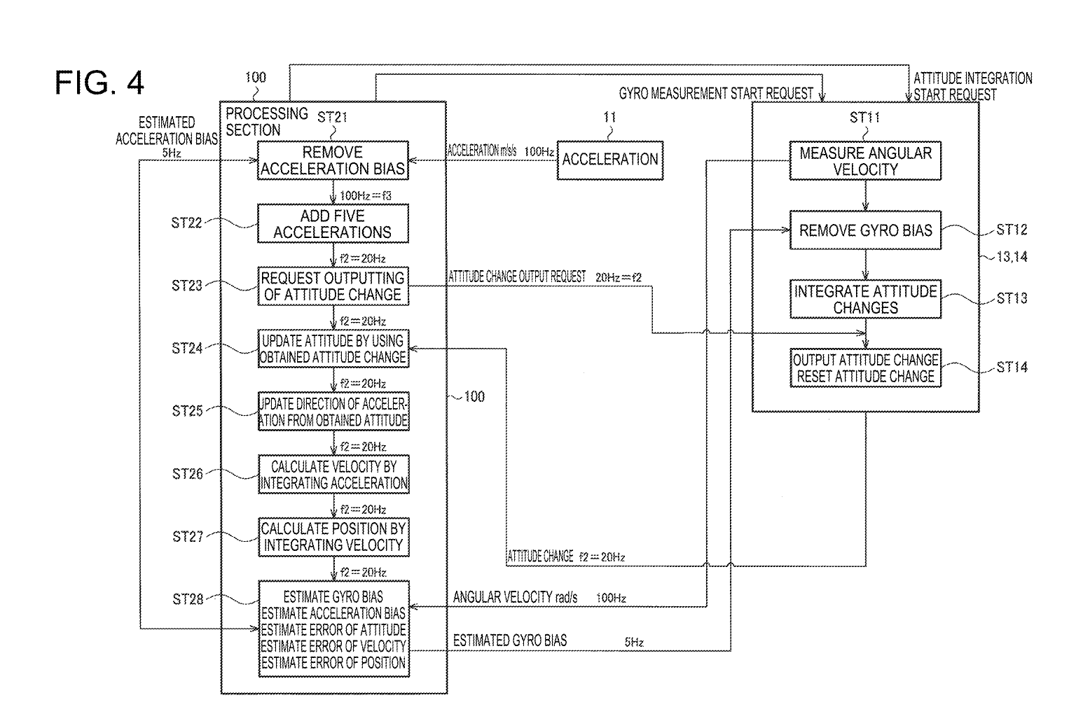

FIG. 3 is a block diagram illustrating main functional blocks of the gyro sensor IC 14 and the processing section 100. FIG. 4 illustrates a sequence operation of the functional blocks illustrated in FIG. 3. In the present embodiment, among constituent elements described below, a function of the attitude calculation apparatus is realized by at least an attitude change calculation unit 113 and an attitude update unit 124. The attitude calculation apparatus may further include at least one of the gyro sensor 13 or the gyro sensor IC 14, the acceleration sensor 11, and a coordinate conversion unit 125.

In FIGS. 3 and 4, the gyro sensor IC 14 includes an A/D converter 111 which samples angular velocity detected by the gyro sensor 13, for example, at a first frequency f1 (for example, f1=7.81 kHz) so as to A/D convert the angular velocity; a digital signal processor (DSP) 112 which performs a digital signal process such as digital filtering; and the attitude change calculation unit 113 which calculates an attitude change of a moving object on the basis of angular velocity from the DSP 112. The attitude change calculation unit 113 includes a gyro bias correction portion 113A which corrects a bias of angular velocity. The attitude change calculation unit 113 calculates an attitude change of a moving object on the basis of angular velocity which is input from the DSP 112 at the first frequency f1.

As illustrated in FIG. 4, angular velocity is measured by the gyro sensor 13 (ST11). In the attitude change calculation unit 113 to which the angular velocity is input via the A/D converter 111 and the DSP 112, first, a gyro bias is removed by the gyro bias correction portion 113A (ST12). The attitude change calculation unit 113 integrates the angular velocity which is input from the DSP 112 at the first frequency f1 over a period (a second period τ₂) defined by a second frequency f2 (for example, f2=20 Hz) on the basis of an attitude output request from the processing section 100, so as to calculate an attitude change of a moving object (ST13). The attitude change calculation unit 113 outputs the calculated attitude change and then resets the attitude change (ST14).

The processing section 100 includes an A/D converter 121 which samples acceleration detected by the acceleration sensor 11, for example, at a third frequency f3 (for example, f3=100 Hz) so as to A/D convert the acceleration; an acceleration bias correction unit 122 which corrects a bias of the acceleration; and an addition averaging unit 123 which adds and averages m accelerations (where m is an integer of 2 or higher, and satisfies (f3/f2)−1<m≧f3/f2); for example, m=5) which have been sampled at the third frequency f3, and outputs the acceleration at an output frequency of the second frequency f2. As illustrated in FIG. 4, the processing section 100 removes a bias of the acceleration from the acceleration sensor 11 after A/D conversion is performed (ST21), and adds and averages five accelerations (ST22).

As illustrated in FIG. 3, the processing section 100 further includes the attitude update unit 124 which updates an attitude of the moving object on the basis of the attitude change which is output from the attitude change calculation unit 113 at the second frequency f2. The attitude change calculation unit 113 calculates an attitude change of the moving object on the basis of angular velocity which is input from the DSP 112 at the first frequency f1. The attitude change calculation unit 113 outputs an attitude change to the attitude update unit 124 at an output frequency of the second frequency f2 in response to a request from the attitude update unit 124. As illustrated in FIG. 4, the processing section 100 outputs an attitude change request to the attitude change calculation unit 113 on the basis of the second frequency f2 (ST23), and updates an attitude by using an attitude change obtained from the attitude change calculation unit 113 (ST24).

The processing section 100 further includes the coordinate conversion unit 125. The coordinate conversion unit 125 calculates acceleration (hereinafter, referred to as “second coordinate system acceleration”) of the moving object whose coordinates are converted from the first coordinate system to the second coordinate system on the basis of the attitude of the moving object which is updated by the attitude update unit 124 according to the second frequency f2 and the acceleration which is input at the second frequency f2. As illustrated in FIG. 4, the processing section 100 updates a direction of the acceleration of the moving object from the obtained attitude (ST25).

The processing section 100 further includes a velocity/position calculation unit 126. As illustrated in FIG. 4, the velocity/position calculation unit 126 integrates the second coordinate system acceleration which is output from the coordinate conversion unit 125 so as to calculate velocity and a position of the moving object in the second coordinate system (ST26 and ST27).

As mentioned above, the position calculation apparatus 1 calculates a position of a moving object which walks and moves in the second coordinate system (the absolute coordinate system, the moving object coordinate system, or the like). When coordinate conversion is performed from the first coordinate system into the second coordinate system, an attitude of the moving object which is updated by the attitude update unit 124 is used. An attitude (angle) of the moving object can be obtained by updating the previous attitude by using an attitude change which is obtained by the attitude change calculation unit 113 integrating angular velocity which is detected by the gyro sensor 13. The more the data amount (the number of samples) of angular velocity in an integral period, that is, the higher the frequency (input frequency) of the angular velocity which is input to the attitude change calculation unit 113, the higher the accuracy of a calculated attitude. In the present embodiment, a frequency of the angular velocity which is input to the attitude change calculation unit 113 is the first frequency f1, and is higher than the attitude change frequency (the second frequency f2) which is input to the attitude update unit 124. Therefore, even in a case where an angular velocity change is relatively great as in a moving object which walks and moves, it is possible to minimize a reduction in integration accuracy when compared with a case of performing integration at the second frequency f2. On the other hand, the attitude change frequency which is input to the attitude update unit 124 is the second frequency f2 which is lower than the first frequency f1. Thus, a load on the CPU in calculation after an attitude is updated is reduced when compared with a case where an attitude change is input to the attitude update unit 124 at the first frequency f1.

The processing section 100 further includes an extended Kalman filter calculation unit 127 and an error correction unit 128. As illustrated in FIG. 4, the extended Kalman filter calculation unit 127 estimates errors of a position, velocity, and azimuth by using an extended Kalman filter on the basis of attitude data output from the attitude update unit 124, position data and velocity data output from the velocity/position calculation unit 126, positioning data (position, velocity, and azimuth) of the GPS sensor 15, and acceleration whose bias is corrected by the acceleration bias correction unit 122 (ST28). In addition, the extended Kalman filter calculation unit 127 estimates a gyro bias and an acceleration bias, which are respectively output to the acceleration bias correction unit 122 and the gyro bias correction portion 113A. The error correction unit 128 corrects a position, velocity, and an attitude of the moving object by using the errors of the position, the velocity and the attitude estimated by the extended Kalman filter calculation unit 127. Information from the error correction unit 128 is an output of the processing section 100.

### 3. SPECIFIC EXAMPLE OF GYRO SENSOR IC

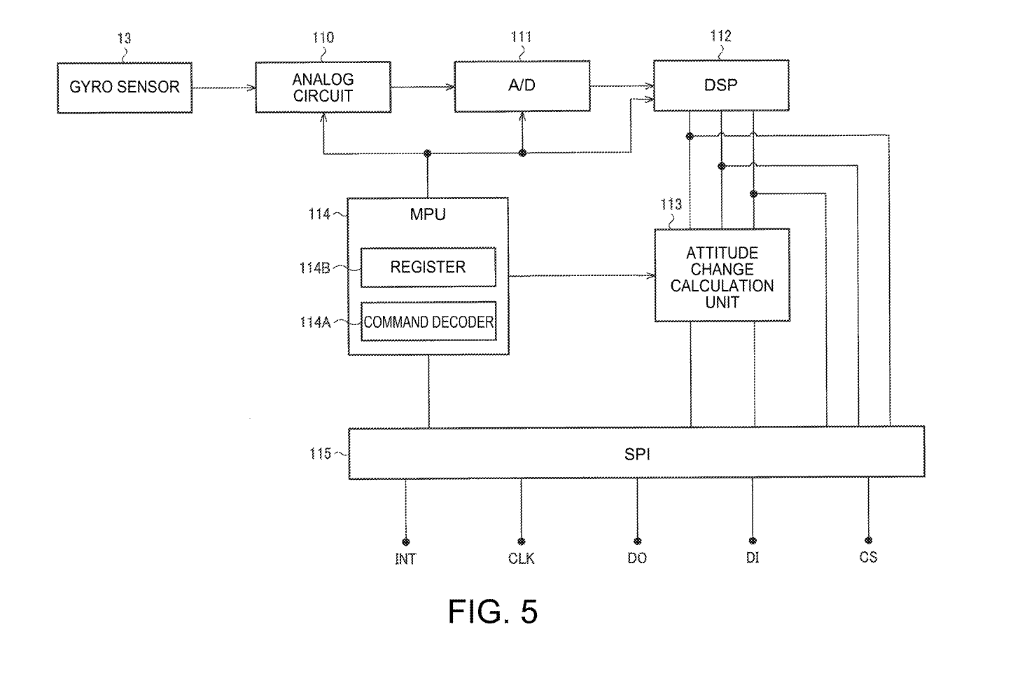

FIG. 5 illustrates a specific example of the gyro sensor IC 14. In FIG. 5, an analog circuit 110, an MPU 114, and a serial-parallel interface (SPI) 115 are provided in addition to the configuration illustrated in FIG. 3.

The analog circuit 110 performs Q-V conversion on an output of the gyro sensor 13 so as to amplify the output. The MPU 114 controls the analog circuit 110, the A/D converter 111, the DSP 112, the attitude change calculation unit 113, and the SPI 115 on the basis of command/data which is input from the SPI 115. For this, the MPU 114 includes a command decoder 114A and a register 114B. Various control data items are stored on the basis of commands decoded by the command decoder 114A, and each unit of the gyro sensor IC 14 is controlled on the basis of the control data. The SPI 115 is provided with an interrupt terminal INT in addition to a chip select terminal CS, a data-in terminal DI, a data-out terminal DO, and a clock terminal CLK connected to the processing section 100. The MPU 114 receives a request command from the attitude update unit 124 of the processing section 100 via the SPI 115. The request command is a command for a request for outputting an attitude change from the attitude change calculation unit 113 with the second frequency f2 as an output frequency. The request decoded by the command decoder 114A is sent to the attitude change calculation unit 113 via the register 114B, and thus an attitude change is output. An interrupt output may be output from the interrupt terminal INT to the processing section 100 in the cycle of the second frequency f2, and a command (request signal) for a request for outputting an attitude change may be issued during the occurrence of interruption.

As control values which are set in the register 114B by a write (W) command decoded by the command decoder 114A, there may be the order of an approximate function, bias update timing, an angular velocity conversion (quantization unit LSB→rad/s) coefficient, DRDY output timing, attitude calculation start/stop, writing of a bias estimation value, and the like. In addition, reading of an attitude change calculation result may be performed following a read (R) command decoded by the command decoder 114A. Attitude change calculation start/stop timing may match a second cycle τ₂ (τ₂=1/f2) of the second frequency f2.

Here, an example of calculation performed by the attitude change calculation unit 113, the attitude update unit 124, and the coordinate conversion unit 125 is represented in the following Equation (1).

C_{b}^{e}(t+τ₂)=C_{b}^{e}(t)C_{change}−Ωᵢₑ^{e}C_{b}(t)τ₂ (1)

In the present specification, a coordinate conversion matrix is indicated by the capital letter “C”. In each coordinate conversion matrix, a subscript character indicates a coordinate system before coordinate conversion, and a superscript character indicates a coordinate system after the coordinate conversion. For example, “C_{b}^{e}” indicates a coordinate conversion matrix from the local coordinate system (B frame) into the absolute coordinate system (E frame).

The left side of Equation (1) indicates an attitude at the time point t+τ₂. C(t) indicates a rotation matrix of an attitude at the time point t. C_{change} indicates an attitude change between the time point t and the time point t+τ₂. The negative term of the right side of Equation (1) indicates influence of the rotation of the Earth. The influence of the rotation of the Earth may be omitted.

C_{change} of Equation (1) can be expressed by Equation (2).

C_{change}=exp([α_{ib}^{b}(t+τ₁)]×)exp([α_{ib}^{b}(t+2τ₁)]×) . . . exp([α_{ib}^{b}(t+kτ₁)]×) (2)

In Equation (2), τ₁ is 1/f1, and k is an integer satisfying (f1/f2)−1<k≦f1/f2. In the present specification, the base e=2.781 . . . of a natural logarithm, raised to the power of d is indicated by “exp(d)” (where d is any value, matrix, expression, or the like). In the present specification, exp([α(t+nτ₁)]×) is referred to as a coordinate conversion matrix. Equation (2) indicates that attitude changes are calculated for each second cycle τ₂ by multiplying a total number k of coordinate conversion matrices which are calculated at intervals of the first cycle τ₁ in the period of the second cycle τ₂ by each other.

In Equation (2), α(t+n′τ₁) is a matrix obtained from angular velocity, and satisfies the following Equation (3). Here, n is an integer satisfying 1≦n≦k.

α_{ib}^{b}(t±nτ₁)=ω_{ib}^{b}(t+nτ₁)τᵢ (3)

The right side of Equation (3) is to express a rotation angle between the I frame and the B frame in the B frame at the time point (t+nτ₁), and is angular velocity obtained from a detected value of the gyro sensor 13. Thus, the matrix ([α(t+nτ₁)]×) of the right side of Equation (2) is a matrix obtained from angular velocity, and is as in the following Equations (4-1) and (4-2).

$$\begin{matrix}( [ {α}_{ib}^{b } ( t + n {τ}_{1} ) ] \times ) = [ \begin{matrix}0 & - {ω}_{ibn}^{b} ( 1 , 3 ) \cdot {τ}_{1} & {ω}_{ibn}^{b} ( 1 , 2 ) \cdot {τ}_{1} \\ {ω}_{ibn}^{b} ( 1 , 3 ) \cdot {τ}_{1} & 0 & - {ω}_{ibn}^{b} ( 1 , 1 ) \cdot {τ}_{1} \\ - {ω}_{ibn}^{b} ( 1 , 2 ) \cdot {τ}_{1} & {ω}_{ibn}^{b} ( 1 , 1 ) \cdot {τ}_{1} & 0\end{matrix} ] & ( 4 \text{-} 1 ) \\ [ \begin{matrix}{ω}_{ib}^{b} ( 1 ) ( t + n {τ}_{1} ) \\ {ω}_{ib}^{b} ( 2 ) ( t + n {τ}_{1} ) \\ {ω}_{ib}^{b} ( 3 ) ( t + n {τ}_{1} )\end{matrix} ] [ \begin{matrix}\begin{matrix}( Angular velocity in x axis at time t + n {τ}_{1} ) - \\ ( Gyro bias in x axis )\end{matrix} \\ \begin{matrix}( Angular velocity in y axis at time t + n {τ}_{1} ) - \\ ( Gyro bias in y axis )\end{matrix} \\ \begin{matrix}( Angular velocity in z axis at time t + n {τ}_{1} ) - \\ ( Gyro bias in z axis )\end{matrix}\end{matrix} ] & ( 4 \text{-} 2 )\end{matrix}$$

As expressed in Equation (4-2), each element of the right side of Equation (4-1) is a value obtained by applying the first cycle τ₁ to a value which is obtained by correcting a detected value for each axis of the gyro sensor at the time point (t+nτ₁) with a gyro bias.

Here, in order to calculate exp(α), first-order to third-order approximation expressed in the following Equations (5) to (7) may be used.

$$\begin{matrix} exp ( [ {α}_{ib}^{b} ( t ) ] \times ) = [ \begin{matrix}1 & 0 & 0 \\ 0 & 1 & 0 \\ 0 & 0 & 1\end{matrix} ] + ( [ {α}_{ib}^{b} ( t ) ] \times ) & ( 5 ) \\ exp ( [ {α}_{ib}^{b} ( t ) ] \times ) = [ \begin{matrix}1 & 0 & 0 \\ 0 & 1 & 0 \\ 0 & 0 & 1\end{matrix} ] + ( [ {α}_{ib}^{b} ( t ) ] \times ) + \frac{{( [ {α}_{ib}^{b} ( t ) ] \times )}^{2}}{2} & ( 6 ) \\ exp ( [ {α}_{ib}^{b} ( t ) ] \times ) = [ \begin{matrix}1 & 0 & 0 \\ 0 & 1 & 0 \\ 0 & 0 & 1\end{matrix} ] + ( [ {α}_{ib}^{b} ( t ) ] \times ) + \frac{{( [ {α}_{ib}^{b} ( t ) ] \times )}^{2}}{2} + \frac{{( [ {α}_{ib}^{b} ( t ) ] \times )}^{3}}{6} & ( 7 )\end{matrix}$$

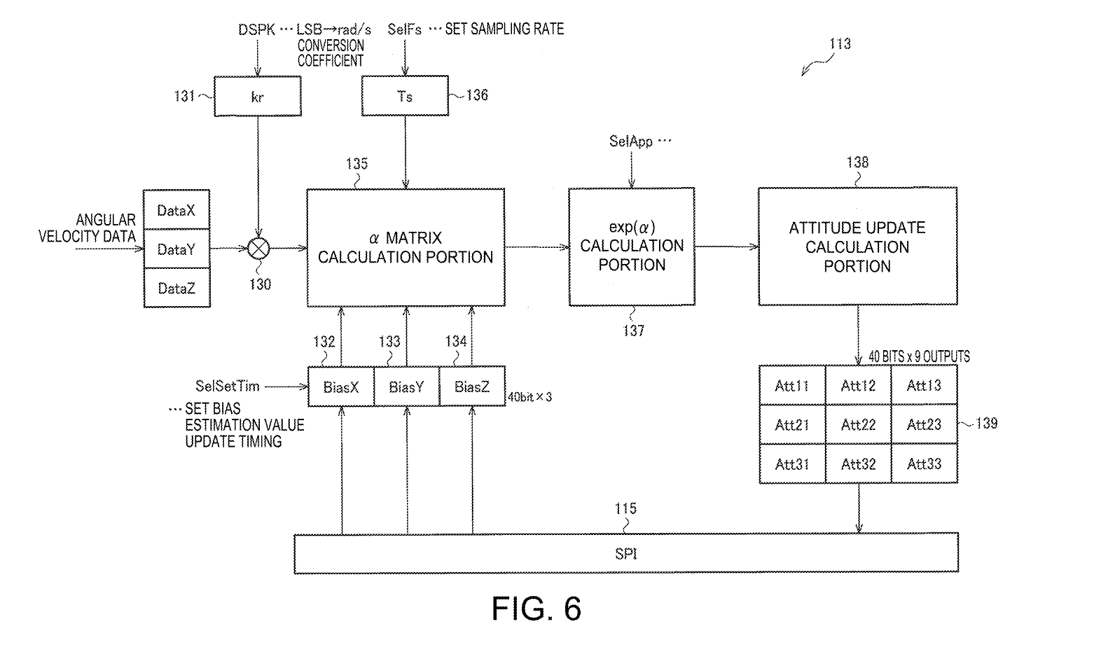

FIG. 6 is a functional block diagram of the attitude change calculation unit 113. In addition, registers 131 to 134, 136 and 139 illustrated in FIG. 6 are specific examples of the register 114B illustrated in FIG. 5. Data on angular velocity (hereinafter, referred to as “angular velocity data”) which is input from the gyro sensor 13, is input to a multiplier 130 illustrated in FIG. 6. The multiplier 130 multiplies the angular velocity data by a coefficient kr of the register 131 so as to convert the unit of the angular velocity into rad/s. Coefficients stored in the register 131 may be stored on the basis of a write command of the command decoder 114A illustrated in FIG. 5. The registers 132 to 134 store bias correction values (negative values) of Equation (4-2), and the bias correction values are subtracted from the angular velocity by an adder of an a matrix calculation portion 135. The adder corresponds to the gyro bias correction portion 113A. The bias correction values are set in the registers 132 to 134 from the extended Kalman filter calculation unit 127 via the SPI 115 at a predetermined timing. The a matrix calculation portion 135 performs matrix calculation of Equation (4-1).

In an exp(α) calculation portion 137, any one of approximate calculation of Equations (5) to (7) is selected by a control signal SelApp which is set in a register (not illustrated) on the basis of a write command of the command decoder 114A illustrated in FIG. 5, and any one of approximate calculation of Equations (5) to (7) is performed. An attitude change update portion 138 stores a result obtained by multiplying a change in the past by the latest attitude change data from the exp(a) calculation portion 137 according to Equation (2), in the register 139. The attitude change data stored in the register 139 is a 3×3 matrix, and corresponds to C_{change} of Equation (2). As for C_{change}, C_{change} of Equation (2) is sent to the attitude update unit 124 via the SPI 115 as, for example, 40 bits×9 outputs, according to a request (command signal) from the attitude update unit 124.

### 4. ATTITUDE CHANGE CALCULATION UNIT CONFIGURED BY HARDWARE

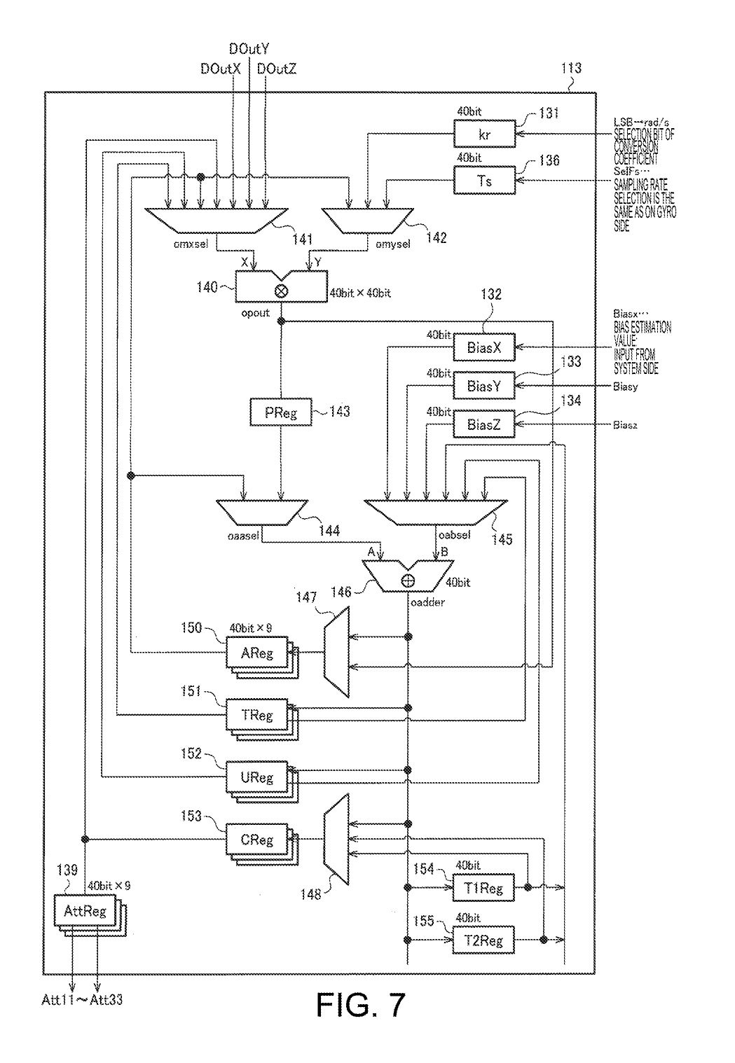

FIG. 7 is a circuit diagram illustrating an example in which the attitude change calculation unit 113 is configured by hardware. In FIG. 7, in order to realize the functions of the α matrix calculation portion 135 and the exp(α) calculation portion 137 illustrated in FIG. 6 by using hardware, selectors 141, 142, 144, 145, 147 and 148 which select register outputs or the like, registers 143, and 150 to 155, a multiplier 140, and an adder 146 are provided. The registers 131 to 134 and 136 illustrated in FIG. 7 are also specific examples of the register 114B illustrated in FIG. 5.

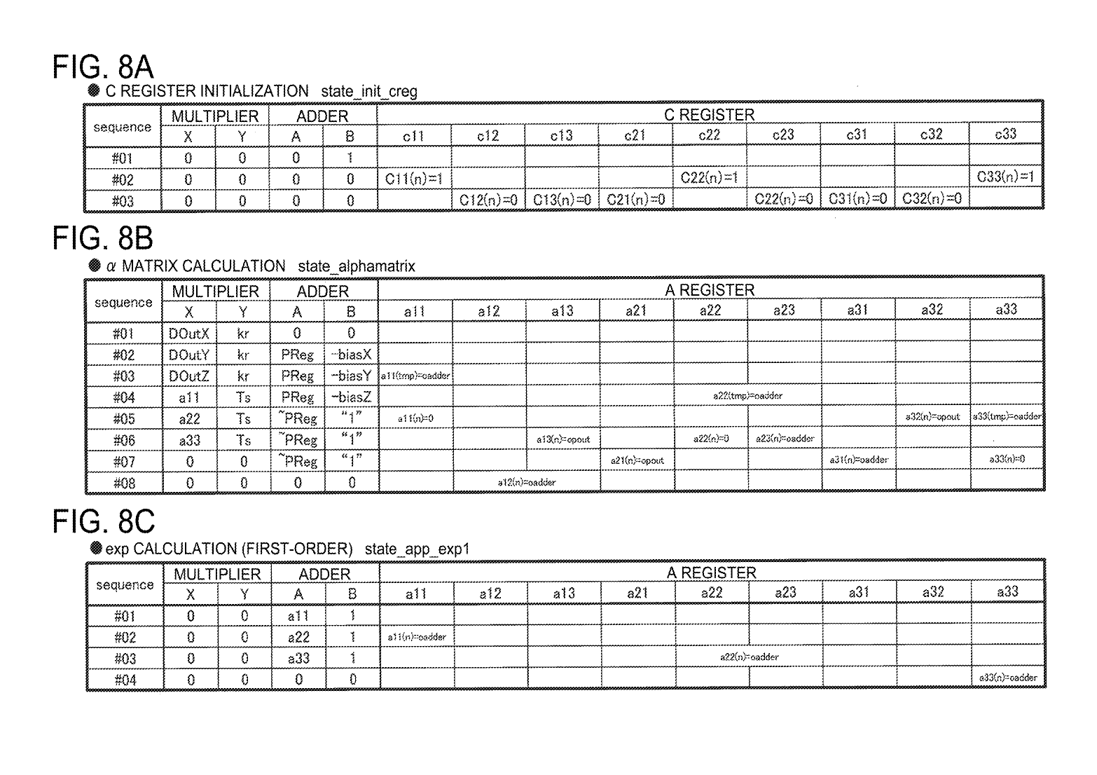

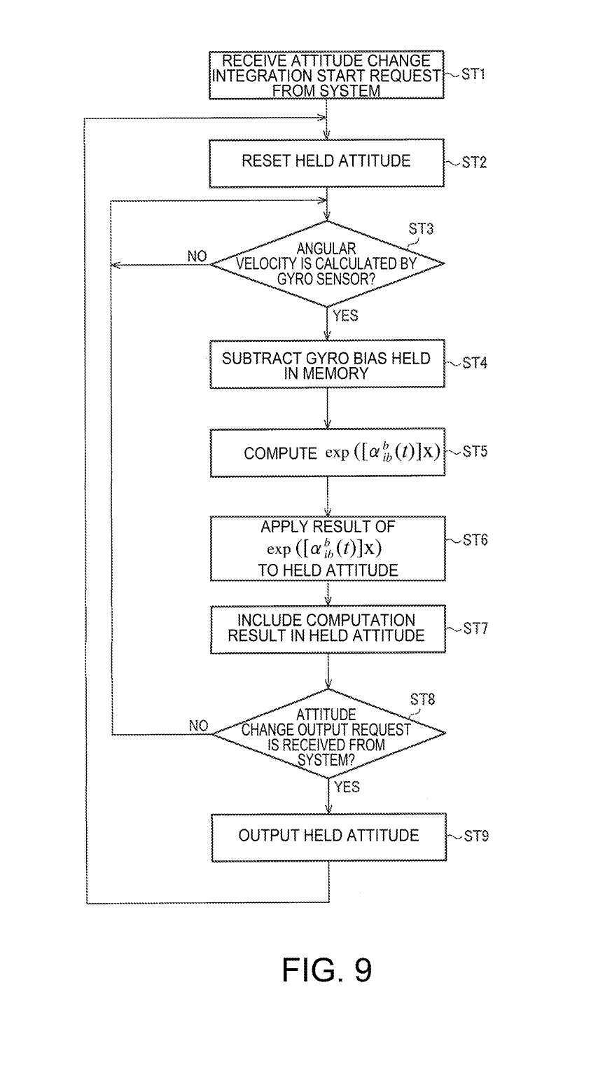

Among operations of the attitude change calculation unit 113 illustrated in FIG. 6, initialization of the C register 153, α matrix calculation, and a calculation operation through the first-order approximation illustrated in FIG. 5 are illustrated in FIGS. 8A to 8C, and FIG. 9. When an integration start request command of attitude changes is input from the system (the processing section 100) in step ST1 of FIG. 9, an attitude change which is computed in the past and is stored (held) in the C register 153 is reset (erased) (ST2). Specifically, as illustrated in FIG. 8A, an initialization operation of the C register 153 illustrated in FIG. 7 is started. In sequences (sequences in FIGS. 8A to 8C, which is also the same for the following) 1 to 3, a constant of 1 or 0 is set in terminals X and Y of the multiplier 140 and terminals A and B of the adder 146, and thus regions c11, c22 and c33 of C register 153 are set to 1, and other regions thereof are set to 0.

In step ST3 of FIG. 9, it is determined whether or not angular velocity is input. If the angular velocity is input (YES in step ST3), steps ST4 and ST5 of FIG. 9 are performed. In other words, FIG. 8B illustrates sequences in which the a matrix calculation portion 135 illustrated in FIG. 6 performs the a matrix calculation represented in Equation (4) by using the hardware illustrated in FIG. 7. In the sequences 1 to 4, a bias of angular velocity data is corrected (step ST4 of FIG. 9), the matrix calculation of Equation (4) is performed in the sequences 4 to 7 (step ST5 of FIG. 9), and a 3×3 matrix is stored in nine regions a11 to a33 of the A register 150 in the sequences 5 to 8. In FIG. 8B, 0 is stored in the regions a11, a22 and a33 of the A register 150, and an output opout of the multiplier 140 or an output oadder of the adder 146 is stored in the other regions a12, a13, a21, a23, a31 and a32 at timings illustrated in FIG. 8B.

Next, step ST6 of FIG. 9 is performed. FIG. 8C illustrates sequences in which the exp(α) calculation portion 137 illustrated in FIG. 6 performs the exp(α) calculation through the first-order approximation represented in Equation (5) by using the hardware illustrated in FIG. 7. In FIG. 8C, the output oadder of the adder 146 is stored in the regions a11, a22 and a33 of the A register 150 at timings illustrated in FIG. 8C (step ST7 of FIG. 9).

The calculation operation of attitude changes illustrated in FIGS. 8A to 8C are repeatedly performed on the angular velocity data which is input at the first frequency f1=7.81 kHz, according to the first cycle τ₁=1/f1. For this reason, as shown in step ST8 of FIG. 9, it is determined whether or not an attitude change output request is received from the system (the processing section 100). While a determination result in step ST8 of FIG. 9 is NO, steps ST3 to ST7 of FIG. 9 are repeatedly performed. If it is determined that there is the output request (command signal), attitude change data is sent to the attitude update unit 124 of the processing section 100 via the C register 153 and an Att register 139. In addition, the T register 151, the U register 152, the T1 register 154, the T2 register 155, and the like may be used to compute second-order and third-order approximation. If a register is further added, it is possible to handle computation of fourth or higher-order approximation. The first frequency f1=7.81 kHz is an example, and calculation using higher frequencies can also be performed.

The velocity/position calculation unit 126 of FIG. 3 calculates the present attitude from Equation (1) by using the present attitude change obtained from Equation (2). The following Equation (8) is calculated so as to obtain acceleration in the E frame on the basis of the present attitude, an attitude obtained in the past, and acceleration detected by the acceleration sensor 11. Here, f_{ib}^{b}(t+τ₂) indicates acceleration at the time point t+τ₂, and is to express acceleration in the B frame for the I frame at the time point t+τ₂, in the B frame.

$${f}_{ib}^{e} ( T + τ 2 ) \approx \frac{1}{2} ( {C}_{b}^{e} ( t ) + {C}_{b}^{e} ( t + τ 2 ) ) {f}_{ib}^{b} ( t + τ 2 ) \qquad ( 8 )$$

Next, the following (9) is calculated by using the acceleration obtained from Equation (8) and velocity obtained in the past, and thus velocity in the E frame is obtained. Here, V_{eb}^{e}(t) is to express velocity in the B frame for the E frame at a time point t, in the E frame. In addition, Equation (9) takes into consideration the gravity and the rotation of the Earth in the third and fourth terms of the right side.

V_{eb}^{e}(t+τᵢ)=v_{eb}^{e}(t)+[f_{ib}^{e}(t+τᵢ)+g_{b}^{e}−2Ωᵢₑ^{e}v_{eb}^{e}(t)]τᵢ (9)

Next, the following Equation (10) is calculated by using a mean value of the present velocity obtained from Equation (9) and velocity obtained in the past, and a previously obtained position, and thus a position in the E frame is obtained.

$${r}_{eb}^{e} ( t + {τ}_{i} ) = {r}_{eb}^{e} ( t ) + \frac{1}{2} ( {v}_{eb}^{e} ( t ) + {v}_{eb}^{e} ( t + {τ}_{i} ) ) {τ}_{i} \qquad ( 10 )$$

### 5. COMPARATIVE EXAMPLE

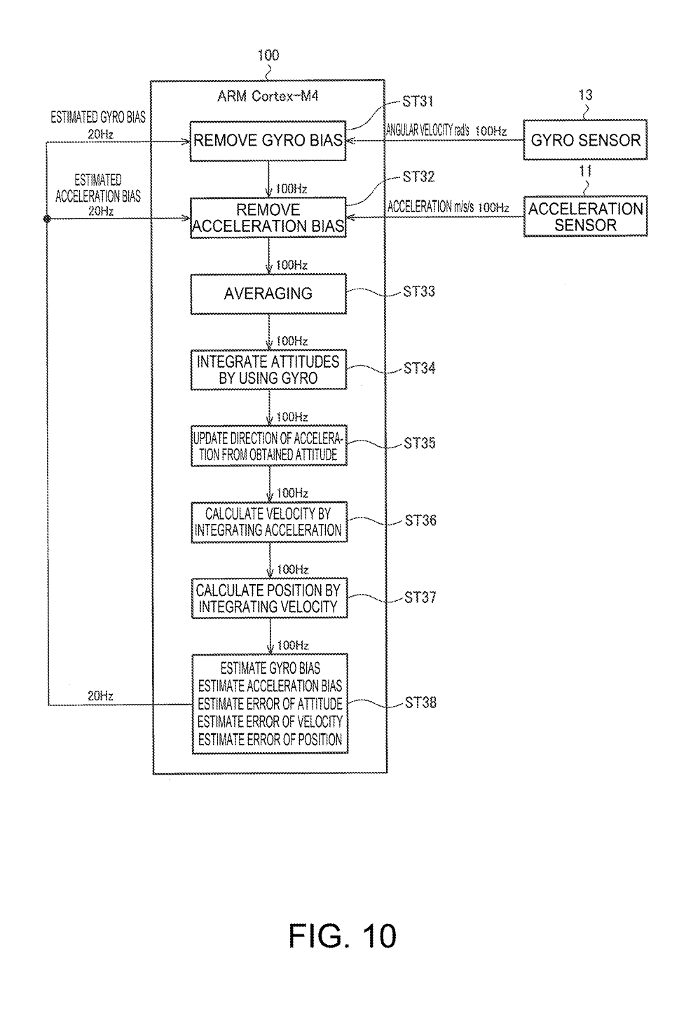

FIG. 10 is a flowchart illustrating an example of a comparative example. In the comparative example illustrated in FIG. 10, acceleration and angular velocity are input to the processing section 100 from the acceleration sensor 11 and the gyro sensor 13 at the same frequency (500 Hz in FIG. 10).

Here, for example, in a case where both operations of calculating an attitude and a position by integrating angular velocity are performed at a frequency of 500 Hz in the processing section 100 illustrated in FIG. 10, a processing load on the processing section 100 increases when compared with a case where calculation is performed at the second frequency f2=20 Hz as in the embodiment.

As a comparative example of a method of reducing a load on the processing section 100, averaging will be described. As in the following Equation (11), angular velocities corresponding to a plurality of data items (a plurality of cycles) are added together without multiplication. This is referred to as averaging. As shown in Equation (11), a single coordinate conversion matrix is not computed every first cycle τ₁, but a coordinate conversion matrix is computed by using a matrix which is obtained by adding angular velocities during a predetermined period (from τ₃ to nτ₃). In this comparative example, since angular velocities of cycles of n=5 are averaged, calculation following computation of exp(α) is performed at f=100 Hz, and thus a computation load can be reduced. In Equation (11), τ₃ indicates a third cycle, and is τ₃=1/f.

C_{b}^{e}(t+nτ₃)=C_{b}^{e}(t)exp([α_{ib}^{b}(t+τ₃)+α_{ib}^{b}(t+2τ₃)+ . . . +α_{ib}^{b}(t+5τ₃)]×) (11)

The averaging of Equation (11) has few errors and can be suitably used in a case where a vehicle or the like which changes relatively a little in angular velocity for a short time is a moving object. However, since a moving object which walks and moves as in the present embodiment has relatively great changes in angular velocity for a short time, it has been found that errors of the averaging are considerable, and attitude calculation accuracy is insufficient.

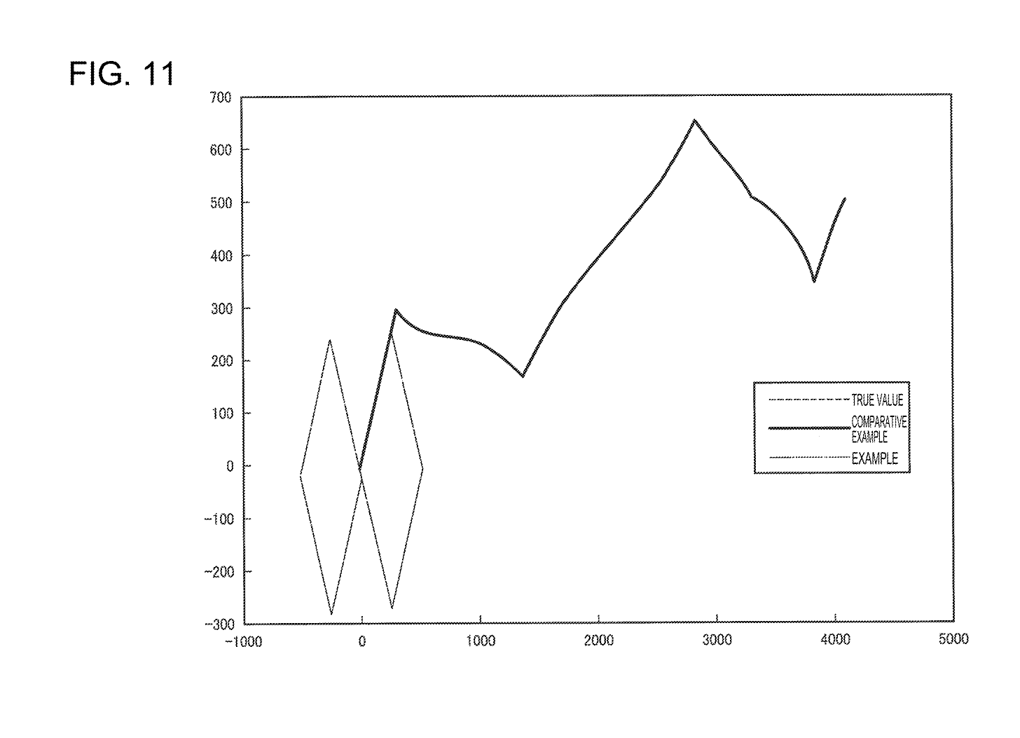

FIGS. 11 to 16 are diagrams illustrating position errors of a moving object calculated in an example of the present embodiment and the comparative example. In FIGS. 11 to 16, on a two-dimensional position coordinate (X,Y), a simulation was performed in which a moving object moves from a start point (0,0) as indicated by arrows of the figure and returns to an end point (0,0), and a position was calculated. In each figure, a longitudinal axis and a transverse axis express position coordinates. The unit is in meters. A dashed line indicates a true value of a trajectory, a dot chain line indicates a result of the present embodiment, and a solid line indicates a result of the comparative example. In the present example employed in FIGS. 11 to 13, the first frequency f1 is set to 7.81 kHz, and the second frequency f2 is set to 100 Hz. On the other hand, in the comparative example employed in FIGS. 11 to 13, angular velocities which were detected at a frequency of 7.81 kHz were averaged, and attitude calculation was performed at f=100 Hz. It was assumed that a human is a moving object, and the comparison was performed in a case where the human moves in three kinds of ways including dashing (running at full speed), running (double-time pace), and walking.

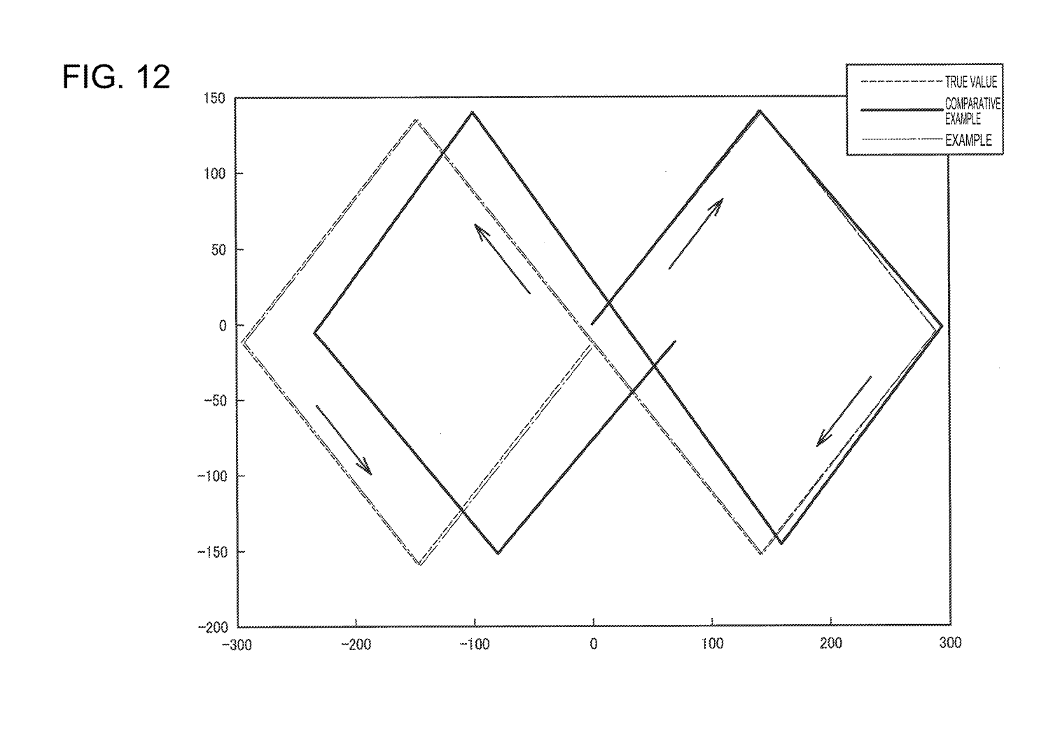

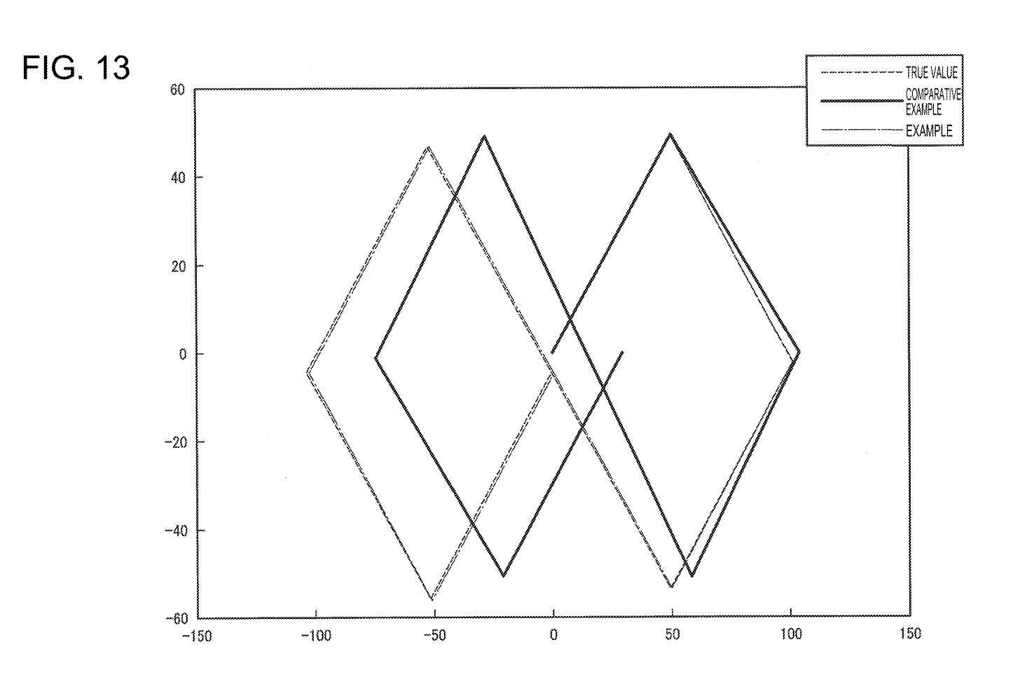

FIG. 11 illustrates an example in which the moving object moves at a dash; FIG. 12 illustrates an example in which the moving object runs and moves; and FIG. 13 is an example in which the moving object moves on foot. In FIGS. 11 to 13, calculation results of the present example were substantially the same as true values, and there are few errors. In contrast, calculation results of the comparative example all have considerable errors, and the calculation results scarcely showed reproducibility in FIG. 11 in which angular velocity changes greatly.

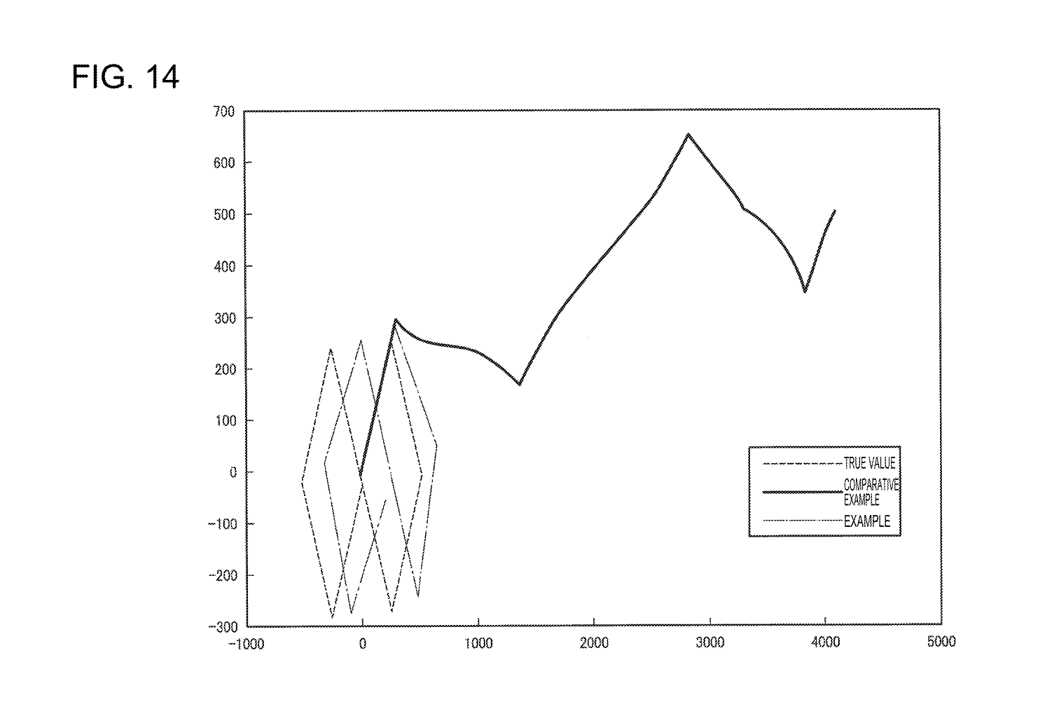

In the present example employed in FIGS. 14 to 16, the first frequency f1 is set to 7.81 kHz, and the second frequency f2 is set to 20 Hz. On the other hand, in the comparative example employed in FIGS. 14 to 16, angular velocities which were detected at a frequency of 7.81 kHz were averaged, and attitude calculation was performed at f=100 Hz in the same manner as in FIGS. 11 to 13.

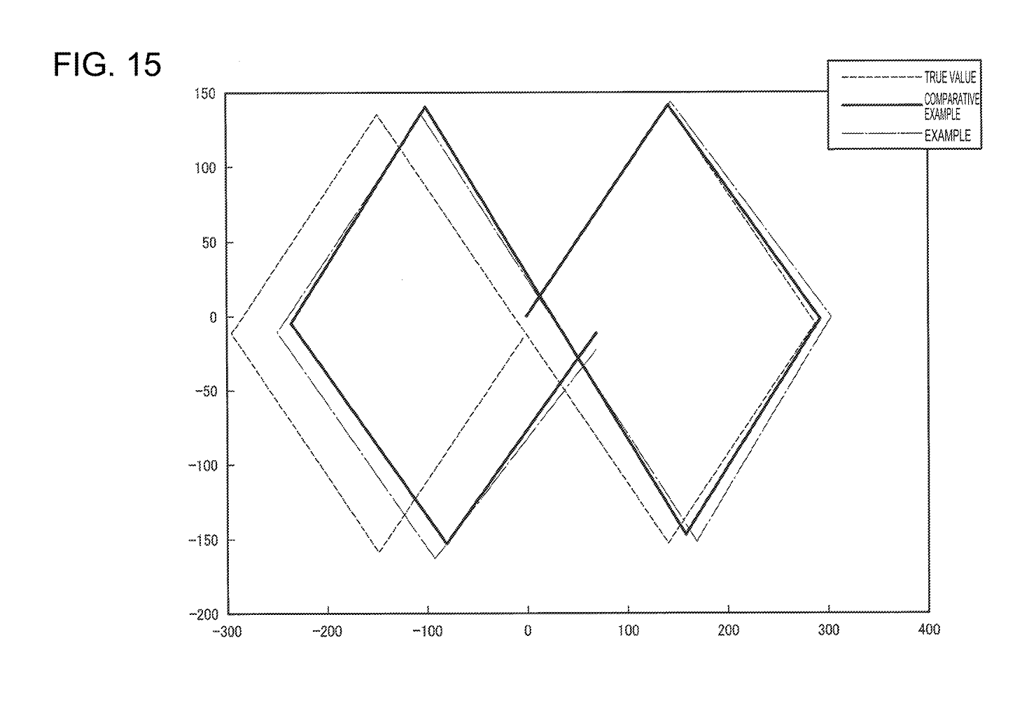

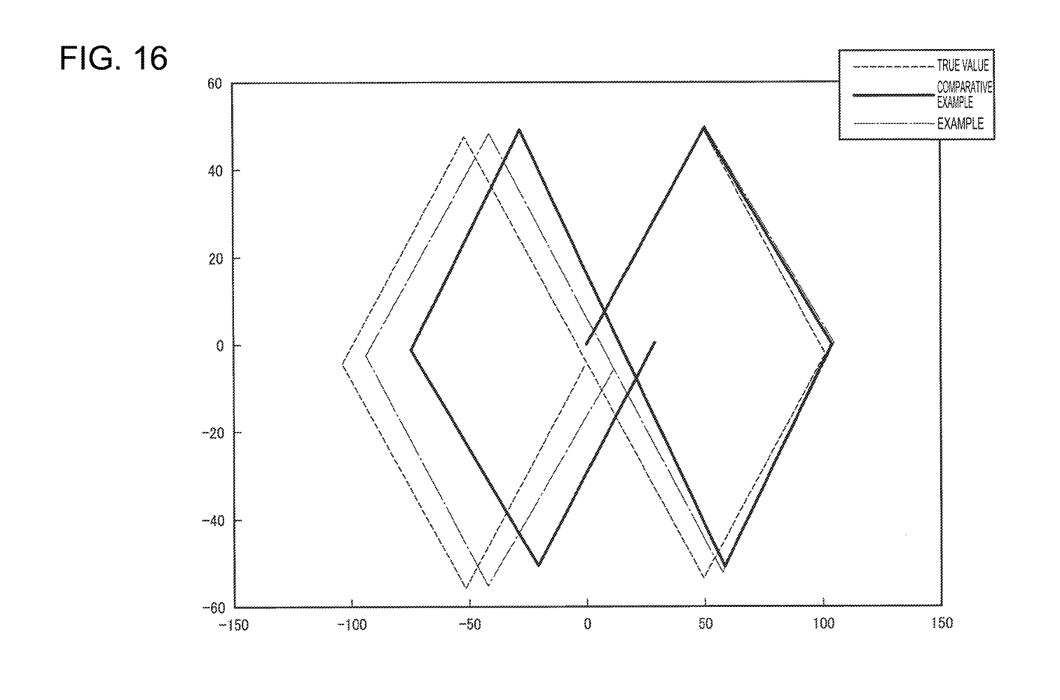

FIG. 14 illustrates an example in which the moving object moves at a dash; FIG. 15 illustrates an example in which the moving object runs and moves; and FIG. 16 is an example in which the moving object moves on foot. As a result of setting the second frequency f2 to be low, calculation results in the example illustrated in FIGS. 14 to 16 have an increasing amount of errors when compared with those illustrated in FIGS. 11 to 13. However, it was found that the amount of errors were fewer than the number of errors in the comparative example which were computed at 100 Hz which is a frequency higher than in the present example. As can be seen from FIG. 16, even in a case where the second frequency f2 is lower than 20 Hz if angular velocity changes to an extent of walking, movement of the moving object can be sufficiently reproduced. Therefore, in the present embodiment, if update of an attitude is performed at f1>f2≧20 Hz, a calculation load can be minimized, and an attitude of a moving object can be appropriately calculated.

### 6. MODIFICATION EXAMPLES

Embodiments to which the invention is applicable are not limited to the above-described embodiment, and may be modified as appropriate within the scope without departing from the invention. Hereinafter, Modification Examples will be described. In addition, the same constituent elements as in the above-described embodiment are given the same reference numerals, and repeated description will be omitted.

### 6-1. Entire Configuration of System

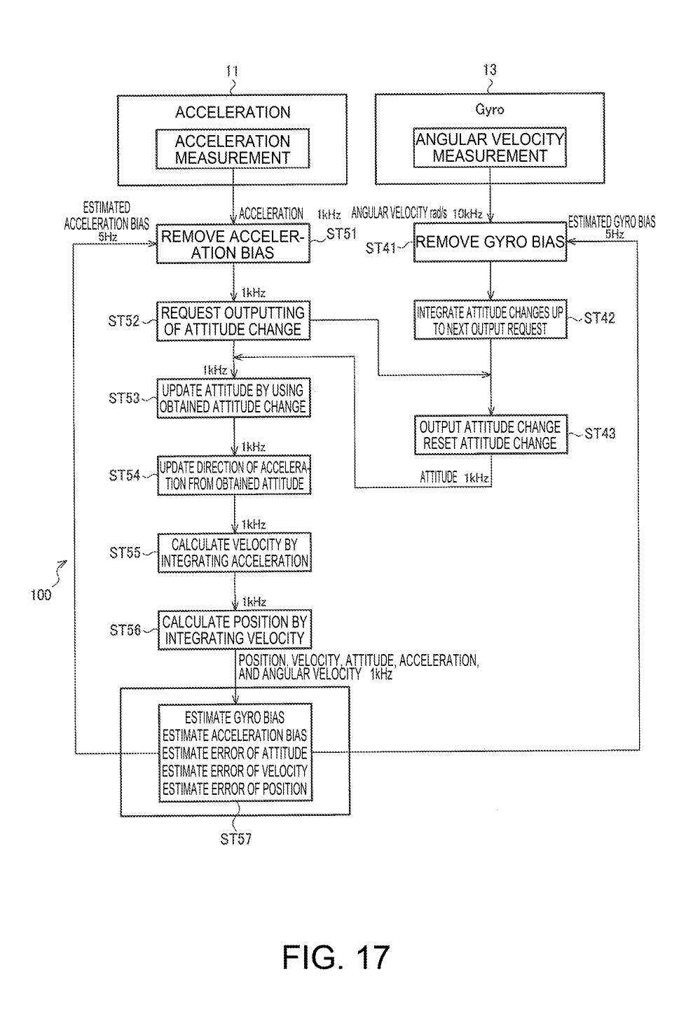

FIG. 17 is an operation flowchart in a modification example in which the functional blocks of the gyro sensor IC illustrated in FIG. 3 are incorporated into the processing section 100, and a main function of the processing section is realized by hardware. Here, steps ST41 to ST43 illustrated in FIG. 17 are the same as steps ST12 to ST14 of FIG. 4. In addition, steps ST51 to ST57 illustrated in FIG. 17 are the same as steps ST21, and ST23 to ST28 of FIG. 4 (an operation corresponding to step ST22 is omitted). Content of calculation in itself is the same as in the embodiment of FIG. 4, and description thereof will be omitted, and a part different from the embodiment of FIG. 4 will be described. In FIG. 17, the first frequency f1 is set to 10 kHz, the second frequency f2 is set to 1 kHz, and the third frequency f3 is set to 1 kHz. Thus, the addition averaging unit 123 illustrated in FIG. 3 is not necessary. Also in this case, as in the above-described embodiment, the attitude change calculation unit 113 is configured by hardware, and thus can perform heavy calculation by using the hardware without putting a load on the CPU.

In addition, since the attitude update unit 124 is also configured by hardware, the second frequency f2 can be set to 1 kHz which is considerably higher than 20 Hz in the above-described embodiment, and thus attitude update can also be performed with high accuracy.

### 6-2. Attitude Calculation Apparatus

In the above-described embodiment, an example in which the position calculation apparatus 1 includes a function of an attitude calculation apparatus has been described, but the attitude calculation apparatus may be configured as a standalone apparatus. For example, the attitude calculation apparatus may include the gyro sensor 13, the gyro sensor IC 14, and the attitude update unit 124.

### 6-3. Attitude Change Calculation Unit

In the above-described embodiment, an example in which the attitude change calculation unit 113 is configured by hardware has been described, but the attitude change calculation unit 113 may be configured by software. In this case, the attitude change calculation unit 113 may be configured as part of the processing section 100.

### 6-4. GPS Sensor

In the above-described embodiment, an example in which the position calculation apparatus 1 includes the GPS sensor 15 has been described, but the GPS sensor may be omitted.

6-5. Moving object

In the above-described embodiment, an example in which a human is a moving object has been described, but a moving object is not limited to a human. In a case where an error of an attitude or a position calculated by applying averaging is not allowable, applying the invention to the case is effective. For example, a living body may be an animal other than a human. Actions of a moving object are not limited to walking or running, and may be jumping, swimming, sliding, flying, and the like. As examples of moving objects which move by using energy of a living body as power source, there are skis, skates, bicycles, hang gliders, boats, sleighs, and the like. The IMU 10 may be mounted on a living body, and may be mounted on a moving object which moves by using energy of a living body as a power source.

It can be easily understood by a person skilled in the art that a lot of modifications can occur without substantially departing from the novel matters and the effects of the invention. Therefore, these modification examples are intended to be included in the scope of the invention. For example, a term which is described at least once along with another term with a broader meaning than or the same meaning as the term may be replaced with another term in any location of the specification or the drawings. In addition, the first and second coordinate systems are not limited to three dimensions, and may be two dimensions.

The entire disclosure of Japanese Patent Application No. 2013-233373, filed Nov. 11, 2013 is expressly incorporated by reference herein.

What is claimed is:

1. An attitude calculation apparatus comprising:
a gyro sensor that detects angular velocity in a first coordinate system for an inertial coordinate system of a moving object;
an attitude change calculation unit that calculates an attitude change of the moving object on the basis of the angular velocity which is input at a first frequency f1; and
an attitude update unit that updates an attitude of the moving object on the basis of the attitude change which is input at a second frequency f2,
wherein the first frequency and the second frequency satisfy f1>f2≧20 Hz.

2. The attitude calculation apparatus according to claim 1,
wherein the attitude change calculation unit calculates exp([α_{ib}^{b}(t+τ₁))]×)exp([α_{ib}^{b}(t+2τ₁)]×) . . . exp([α_{ib}^{b}(t+kτ₁)]×). Here, τ₁ is 1/f1; k is an integer satisfying (f1/f2)−1<k≦f1/f2; t indicates time; and [α_{ib}^{b}(t+nτ₁)] indicates a rotation matrix obtained from the angular velocity at a time point t+nτ₁ (where n is an integer satisfying 1≦n≦k).

3. The attitude calculation apparatus according to claim 2, further comprising:
an acceleration sensor that detects acceleration in the first coordinate system for the inertial coordinate system; and
a coordinate conversion unit that converts coordinates of the acceleration from the first coordinate system into a second coordinate system on the basis of the attitude and the acceleration which is input at the second frequency f2.

4. The attitude calculation apparatus according to claim 1, further comprising:
a sensor unit that includes the gyro sensor,
wherein the attitude change calculation unit is configured by hardware which is accommodated in the sensor unit.

5. The attitude calculation apparatus according to claim 1, further comprising:
an addition averaging unit that adds and averages the m accelerations (where m is an integer of 2 or higher, and satisfies (f3/f2)−1<m≦f3/f2)) which have been input at a third frequency f3 (f2<f3), and inputs the acceleration to the coordinate conversion unit at the second frequency f2.

6. The attitude calculation apparatus according to claim 1,
wherein the attitude update unit outputs a request signal for a request for outputting the attitude change, to the attitude change calculation unit.

7. An attitude calculation method comprising:
detecting angular velocity in a first coordinate system for an inertial coordinate system of a moving object;
calculating an attitude change of the moving object on the basis of the angular velocity which is input at a first frequency f1; and
updating an attitude of the moving object on the basis of the attitude change which is input at a second frequency f2,
wherein the first frequency and the second frequency satisfy f1>f2≧20 Hz.
